(19) United States
(12) Patent Application Publication
(10) Pub. No.: US 2015/0065127 A1
(43) Pub. Date: Mar. 5, 2015

(54) METHODS AND APPARATUS FOR IMPROVING CONNECTED MODE SEARCH

(71) Applicant: QUALCOMM Incorporated, San Diego, CA (US)

(72) Inventors: Subbarayudu MUTYA, Hyderabad (IN); Raghavendra Shyam ANAND, Chickballapur (IN)

(21) Appl. No.: 14/474,910

(22) Filed: Sep. 2, 2014

Related U.S. Application Data
(60) Provisional application No. 61/873,548, filed on Sep. 4, 2013.

(51) Int. Cl. H04W 40/24; H04W 24/08; H04W 88/06

(52) U.S. Cl. CPC H04W 40/246; H04W 88/06; H04W 24/08
USPC 455/434

(57) ABSTRACT

Certain aspects of the present disclosure relate to a method and apparatus for improving connected mode search (e.g., by UE having at least two RF chains). According to aspects, the UE may dynamically configure based, at least in part, on at least one measured signal quality parameter, one of the first or second RF chains to perform a search procedure while the other RF chain communicates with the network. According to aspects, the UE may coordinate a search procedure during compressed mode gaps using both RF chains when a measured at least one signal quality parameter passes a first threshold for both RF chains, wherein a set of one or more carriers searched by the first RF chain is different than a set of one or more carriers searched by the second RF chain.

### CROSS-REFERENCE TO RELATED APPLICATIONS

This application claims benefit of priority to U.S. application Ser. No. 61/873,548 filed Sep. 4, 2013 which is expressly incorporated herein by reference in its entirety.

### BACKGROUND

1. Field

Aspects of the present disclosure generally relate to wireless communications, and more particularly, to methods and apparatus for improving a search procedure (e.g., by a user equipment (UE) having at least two radio frequency (RF) chains), including connected mode searching and searching during compressed mode gaps.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. These improvements should be applicable to other multi-access technologies and the telecommunication standards that employ these technologies.

### SUMMARY

Certain aspects of the present disclosure provide a method for wireless communications by a UE having at least a first and a second RF chain capable of communicating with a network. The method generally includes measuring at least one signal quality parameter of the network using at least one of the first or second RF chains while the UE is communicating with the network, and dynamically configuring based, at least in part, on the at least one measured signal quality parameter one of the first or second RF chains to perform a search procedure while the other RF chain communicates with the network.

Certain aspects of the present disclosure provide a method for wireless communications by a UE having at least a first and a second RF chain capable of communicating with a network. The method generally includes measuring at least one signal quality parameter of the network using the first and second RF chains, and coordinating a search procedure during compressed mode gaps using both RF chains when the measured at least one signal quality parameter passes a first threshold for both RF chains, wherein a set of one or more carriers searched by the first RF chain is different than a set of one or more carriers searched by the second RF chain.

Certain aspects of the present disclosure provide an apparatus having at least a first and a second RF chain capable of communicating with a network. The apparatus generally includes means for measuring at least one signal quality parameter of the network using at least one of the first or second RF chains while the apparatus is communicating with the network, and means for dynamically configuring based, at least in part, on the at least one measured signal quality parameter one of the first or second RF chains to perform a search procedure while the other RF chain communicates with the network.

Certain aspects of the present disclosure provide an apparatus having at least a first and a second RF chain capable of communicating with a network. The apparatus generally includes means for measuring at least one signal quality parameter of the network using the first and second RF chains, and means for coordinating a search procedure during compressed mode gaps using both RF chains when the measured at least one signal quality parameter passes a first threshold for both RF chains, wherein a set of one or more carriers searched by the first RF chain is different than a set of one or more carriers searched by the second RF chain.

Certain aspects of the present disclosure provide an apparatus having at least a first and a second RF chain capable of communicating with a network. The apparatus generally includes a processing system coupled to a memory. The processing system is generally configured to measure at least one signal quality parameter of the network using at least one of the first or second RF chains while the apparatus is communicating with the network, and dynamically configure based, at least in part, on the at least one measured signal quality parameter one of the first or second RF chains to perform a search procedure while the other RF chain communicates with the network.

Certain aspects of the present disclosure provide an apparatus having at least a first and a second RF chain capable of communicating with a network. The apparatus generally includes a processing system coupled to a memory. The processing system is generally configured to measure at least one signal quality parameter of the network using the first and second RF chains, and coordinate a search procedure during compressed mode gaps using both RF chains when the measured at least one signal quality parameter passes a first threshold for both RF chains, wherein a set of one or more carriers searched by the first RF chain is different than a set of one or more carriers searched by the second RF chain.

Certain aspects of the present disclosure provide a computer readable medium storing computer executable code. The code generally includes code for measuring at least one signal quality parameter of the network using at least one of the first or second RF chains while a UE is communicating with the network, and dynamically configuring based, at least in part, on the at least one measured signal quality parameter one of the first or second RF chains to perform a search procedure while the other RF chain communicates with the network.

Certain aspects of the present disclosure provide a computer readable medium storing computer executable code. The code generally includes code for measuring at least one signal quality parameter of the network using the first and second RF chains, and coordinating a search procedure during compressed mode gaps using both RF chains when the measured at least one signal quality parameter passes a first threshold for both RF chains, wherein a set of one or more carriers searched by the first RF chain is different than a set of one or more carriers searched by the second RF chain.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 an exemplary deployment in which multiple wireless networks have overlapping coverage.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 illustrates example operations performed, for example, by a UE, in accordance with certain aspects of the present disclosure.

FIG. 8 illustrates example operations performed, for example, by a UE, in accordance with certain aspects of the present disclosure.

FIG. 9 illustrates an example methodology for evaluating a dual antenna mode timer, in accordance with certain aspects of the present disclosure.

FIG. 10 illustrates an example methodology for performing a cell search by a UE during a dedicated channel (DCH) state, in accordance with certain aspects of the present disclosure.

FIG. 11 illustrates an example methodology for a single channel DCH configuration, in accordance with certain aspects of the present disclosure.

FIG. 12 illustrates an example methodology for compressed mode cell search, in accordance with certain aspects of the present disclosure.

FIG. 13 illustrates an example methodology performed by a device operating in a DCH state, in accordance with certain aspects of the present disclosure.

### DETAILED DESCRIPTION

Aspects of the present disclosure provide techniques for improving searching operations by UE with at least two RF chains. According to aspects, such a UE may be operating in a connected mode and may perform search procedures during a connected mode state using its diversity antenna. In this manner, the UE may not use both RF chains, for receive diversity purposes, to communicate with the network. By dynamically configuring one of the RF chains to perform a search procedure while the other is used to communicate with the network, a UE may be able to connect to a higher-priority cell, for example, a home network, more efficiently.

Further, aspects of the present disclosure provide methods to improve searching in an effort to more efficiently coordinate a cell search procedure during compressed mode gaps. As described herein, when at least one signal quality parameter exceeds a threshold value, the UE may independently use both RF chains for cell searching purposes during compressed mode gaps.

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as code division multiple access (CDMA), time division multiple access (TDMA), frequency division multiple access (FDMA), orthogonal FDMA (OFDMA), single carrier FDMA (SC-FDMA) and other networks. The terms “network” and “system” are often used interchangeably. A CDMA network may implement a radio access technology (RAT) such as universal terrestrial radio access (UTRA), cdma2000, etc. UTRA includes wideband CDMA (WCDMA) and other variants of CDMA. cdma2000 covers IS-2000, IS-95 and IS-856 standards. IS-2000 is also referred to as 1×radio transmission technology (1×RTT), CDMA2000 1×, etc. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), IEEE 802.11 (Wi-Fi), IEEE 802.16 (WiMAX), IEEE 802.20, Flash-OFDM™, etc. UTRA and E-UTRA are part of universal mobile telecommunication system (UMTS). 3GPP long-term evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and RATs mentioned above as well as other wireless networks and RATs.

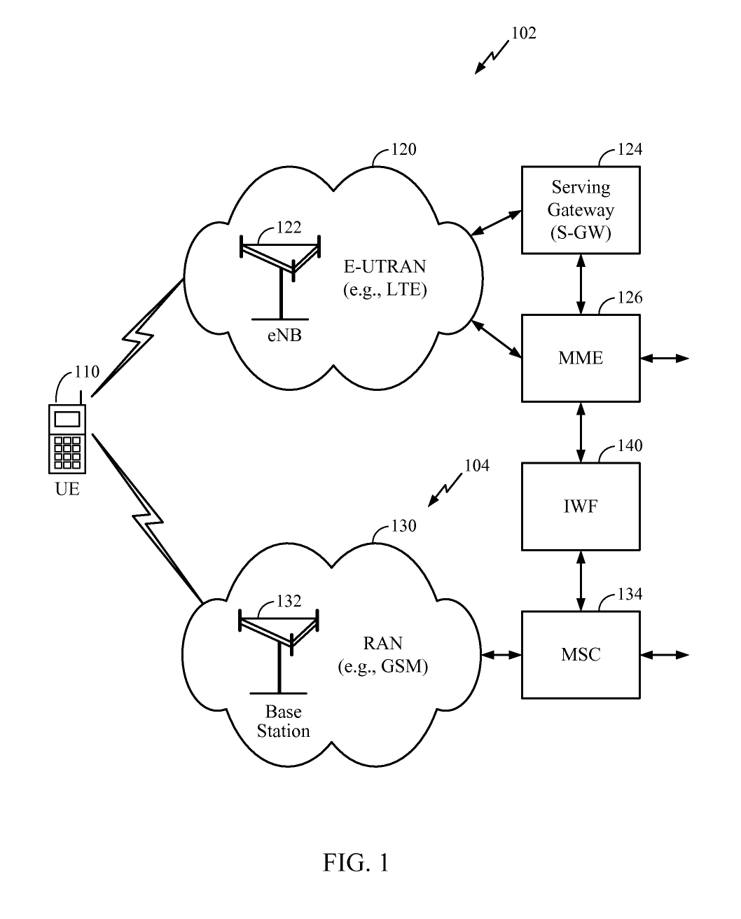

FIG. 1 illustrates an example deployment in which aspects of the present disclosure may be practiced. For example, UE 110 may perform the operations and techniques described herein in an effort to improve searching operations during a connected mode and/or during compressed mode gaps.

FIG. 1 shows an exemplary deployment in which multiple wireless networks have overlapping coverage. An evolved universal terrestrial radio access network (E-UTRAN) 120 may support LTE and may include a number of evolved Node Bs (eNBs) 122 and other network entities that can support wireless communication for user equipments (UEs). Each eNB may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network-triggered services, etc. A mobility management entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A radio access network (RAN) 130 may support GSM and may include a number of base stations 132 and other network entities that can support wireless communication for UEs. A mobile switching center (MSC) 134 may communicate with the RAN 130 and may support voice services, provide routing for circuit-switched calls, and perform mobility management for UEs located within the area served by MSC 134. Optionally, an inter-working function (IWF) 140 may facilitate communication between MME 126 and MSC 134 (e.g., for 1×CSFB).

E-UTRAN 120, serving gateway 124, and MME 126 may be part of an LTE network 102. RAN 130 and MSC 134 may be part of a GSM network 104. For simplicity, FIG. 1 shows only some network entities in the LTE network 102 and the GSM network 104. The LTE and GSM networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency or frequency ranges may also be referred to as a carrier, a frequency channel, etc. Each frequency or frequency ranges may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for voice-over-Internet protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1×RTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

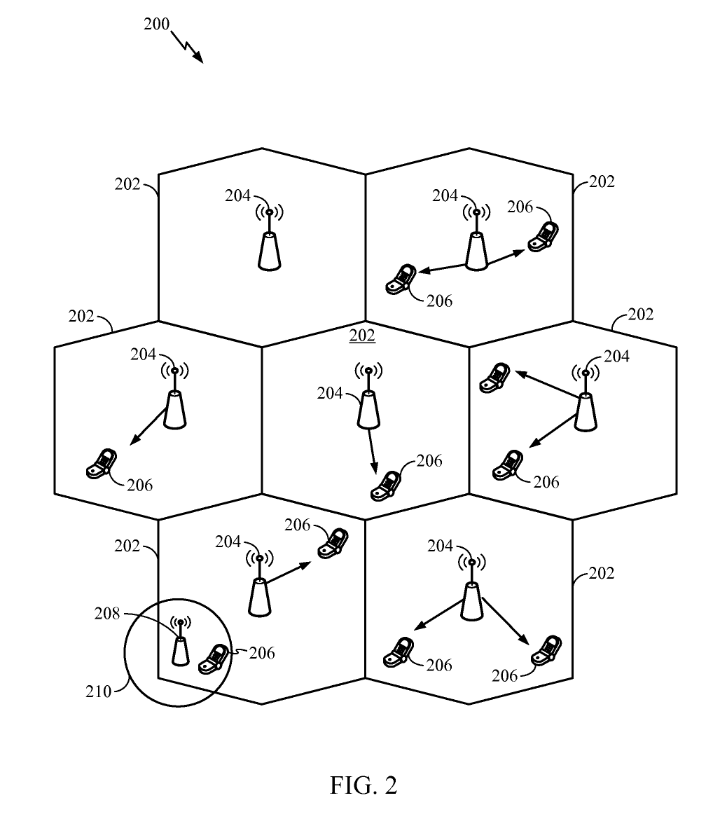

FIG. 2 illustrates an example access network in which aspects of the present disclosure may be practiced. UEs 206 may perform the operations and techniques described herein while searching for a network or higher-priority cell during a connected mode and/or during compressed mode gaps.

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

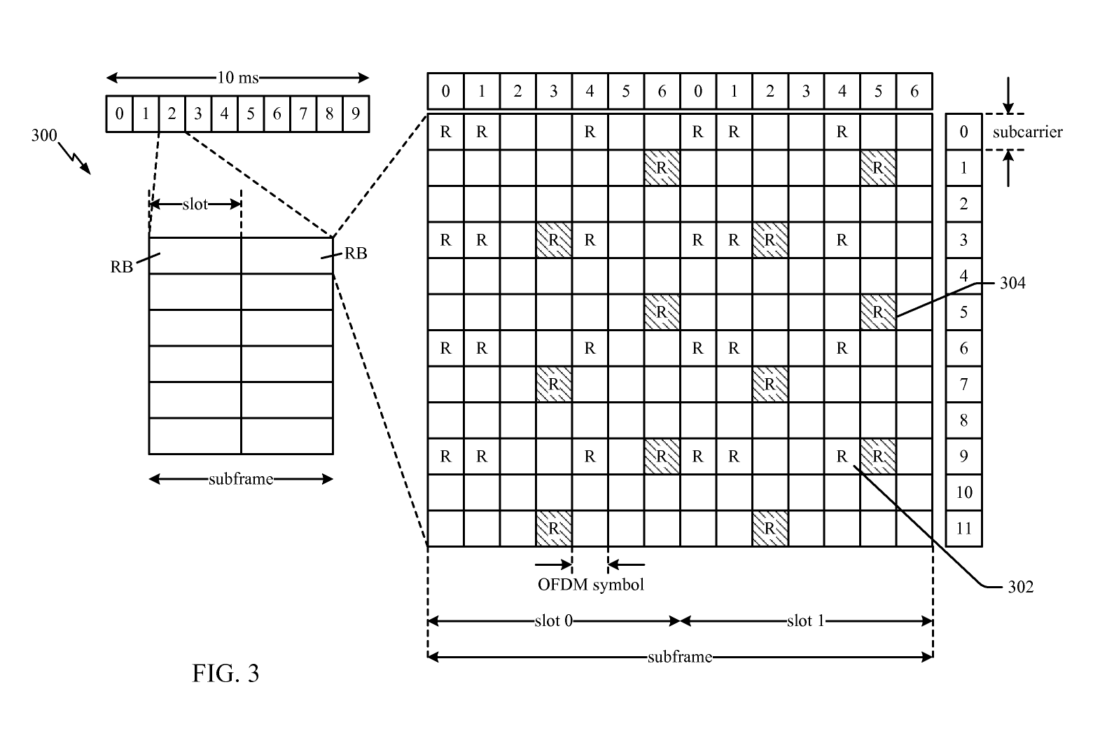

FIG. 3 illustrates an example DL frame structure which may be used by a base station of a network, communicating with a UE 110, 206, according to aspects of the present disclosure. For example, the UE may receive one or more downlink frames in accordance with the illustrated structure and as described herein.

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

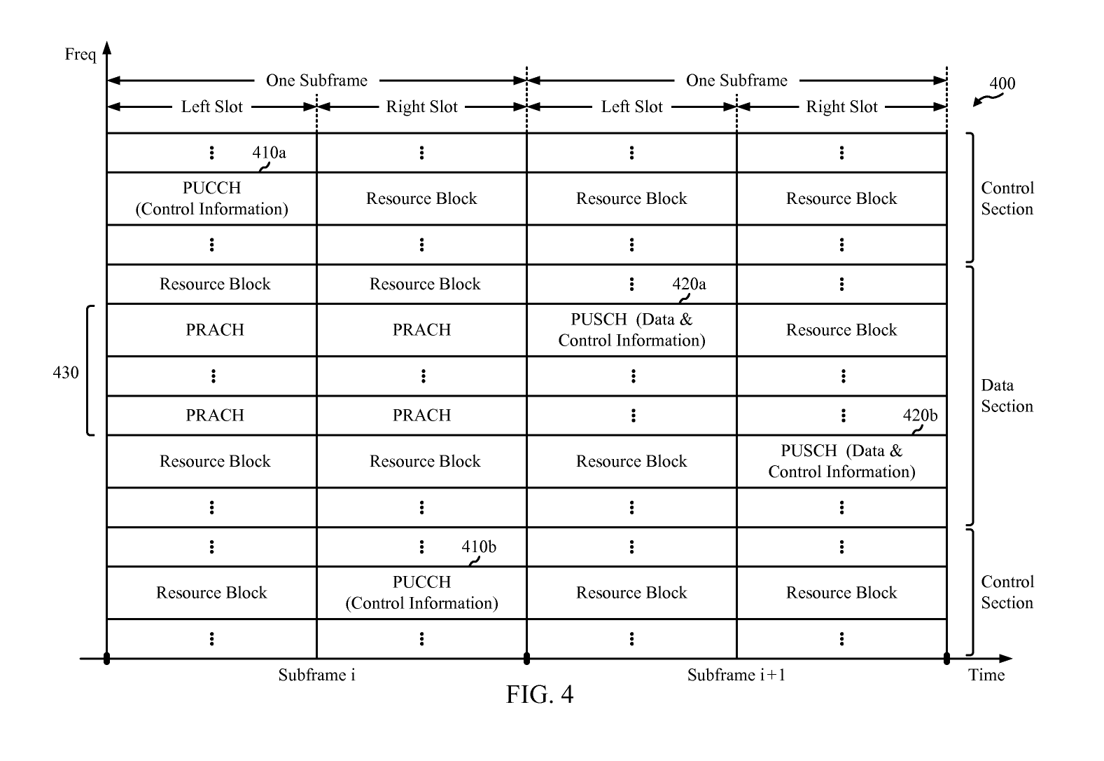

FIG. 4 illustrates an example UL frame structure which may be used by a UE 110, 206 communicating with an access network 200, according to aspects of the present disclosure. For example, the UE may communicate with a base station of the access network using one or more uplink frames in accordance with the structure illustrated and as described herein.

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

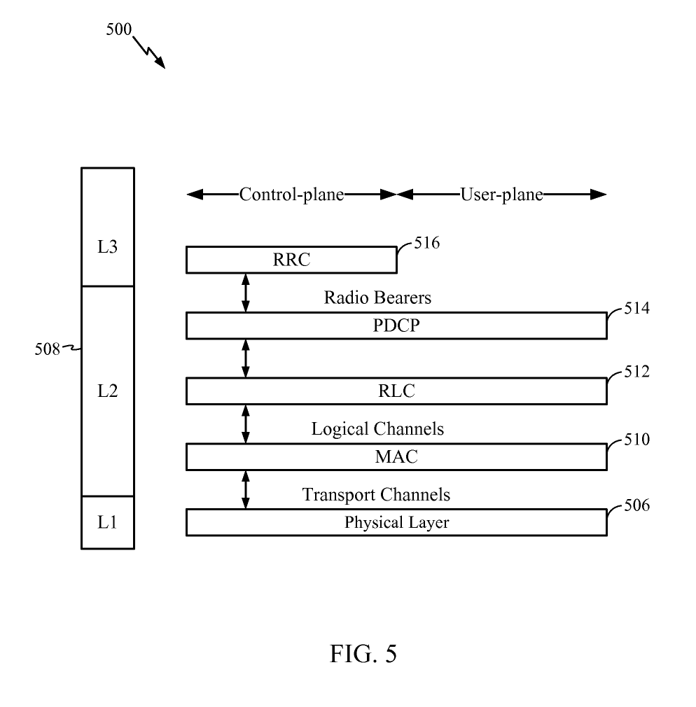

FIG. 5 illustrates an example radio protocol for the UE 110, 206 and eNB, according to aspects of the present disclosure. For example, the UE performing the techniques described herein may include the radio protocol architecture as illustrated and as described herein.

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

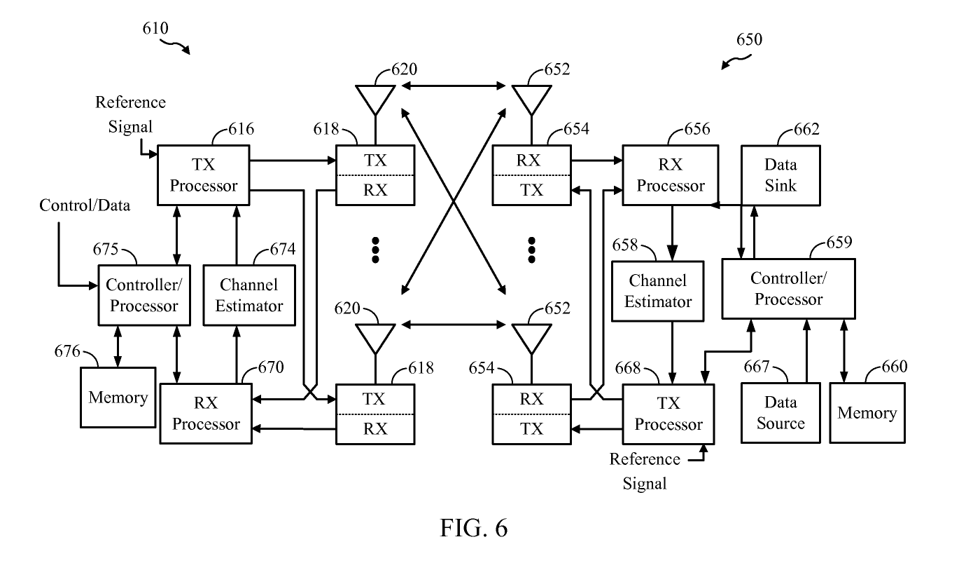

FIG. 6 illustrates an example UE and eNB which may be used to practice aspects of the present disclosure. The UE 650 may be UE 110, 206 of FIGS. 1 and 2, respectively. The UE 650 may have at least a first and second RF chain. One or more components of UE 650 may be used to measure signal quality parameters using the first and second RF chain. The UE 650 may dynamically configure one of the RF chains to communicate with a network while the other RF chain performs a searching procedure. Additionally or alternatively, the UE 650 may coordinate a search procedure during connected mode gaps. For example, the antenna 652, Tx/Rx 654, and controller/processor 659 may perform the operations described herein.

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

### Example Methods and Apparatus for Improving and/or Optimizing Connected Mode Search

Wireless terminals typically use two RF chains in LTE, Time Division Synchronous Code Division Multiple Access (TDSCDMA), and/or WCDMA radio access systems when communicating with the network (e.g., NodeB, eNodeB). The two RF chains may be used for receive diversity purposes. Using two RF chains for receive diversity may improve the signal-to-noise ratio (SNR) of received symbols during a connected mode. However, receive diversity may not be necessary for maintaining a connection with the network.

For example, when a UE roams into a Visited Public Land Mobile Network (VPLMN) and establishes a connection with an eNB through packet-switch (PS) or circuit-switch (CS) connections, a Home Public Land Mobile Network (HPLMN) periodic search is performed using higher layers. The HPLMN search, which may be a type of Background Public Land Mobile Network (BPLMN) search, may be configured to continuously look for available high-priority cells when the UE is roaming

Typically, when an HPLMN scan is triggered by higher layers, a BPLMN search may be triggered by the UE. The BPLMN search may be performed during inactivity periods including, for example, during discontinuous reception (DRX) periods, when the UE is in a connected mode with the network. For WCDMA, when a UE is in a connected mode, the BPLMN search may be performed during a Cell Paging Channel (Cell_PCH) and/or UTRAN Registration Area Paging Channel (URA_PCH) state where there is no activity between the UE and the network.

However, when there is activity between the UE and the network (e.g., signaling or data transfer), the BPLMN search may be rejected. Currently, the UE may not perform a search during a connected mode. Depending on the duration of the data transfer or signaling with the network, the UE may continue to reject BPLMN search requests from higher layers. This may lead to a poor user experience because, for example, the UE may be using resources from the visitor network (e.g., VPLMN) when a home network (e.g., HPLMN) is available.

During connected mode measurements in LTE, TDSCDMA, and/or WCDMA, compressed mode gaps created by an eNB may be used for measurements of interfrequency carriers and/or inter-RAT cells.

However, during compressed mode gaps, the primary and secondary RF chains may be configured such that a UE may tune to and measure inter-frequency or inter-RAT carriers. The UE may subsequently move to the next frequency or next inter-RAT cell to perform measurements.

This procedure may lead to a delay by a UE in reporting stronger cells and/or inefficient use of the primary and diversity RF chains during compressed mode gaps. As such, aspects presented herein describe methods and apparatus for improving connected mode search procedures.

As will be described in more detail herein, in aspects, a UE may perform search procedures during a connected mode state using at least a diversity antenna (e.g., RF chain). According to aspects, the UE may determine search occasions during connected mode operations using the diversity antenna (e.g., RF chain) and/or during compressed mode gaps.

### BPLMN Search During Connected Mode

Currently, PLMN and/or cell search procedures may be triggered during Cell_PCH and URA_PCH discontinuous reception (DRX) periods while the UE is in a connected mode. The DRX periods may vary with network configurations. Hence, a UE may search in DRX cycles of, for example, 320 ms, 640 ms, or 1280 ms.

According to current implementations, a UE may determine if the L1 layer may go sleep. If so, the UE may perform a cell search using the primary RF chain. If the UE is performing signaling or data transfer with the network, the UE may not go to sleep. Hence, the UE may reject search requests.

In an effort to improve and/or optimize connected mode searching, a UE may check (e.g., measure) at least one signal quality parameter using one or more (e.g., both) RF chains. As described herein, Antenna 0 may refer to a first, primary RF chain and Antenna 1 may refer to a second, diversity RF chain. The at least one signal quality parameter may include at least one of Reference Signal Received Power (RSRP), a Reference Signal Received Quality (RSRQ), a Signal-to-Noise Ratio (SNR) or the like.

If at least one signal quality parameter is above a threshold (e.g., Param_X_threshold), the UE may perform a cell search using one of the RF chains according to an algorithm described below.

A UE, such as UE 110 of FIG. 1 including one or more components of UE 650 of FIG. 6, may have two receive chains and may be using one or both chains while communicating with a network (e.g., in a dedicated channel (DCH) state). When there is a need to request a search (e.g., due to HPLMN search pending) the UE may check a signal quality parameter of one or more RF chains (e.g., RSRP, RSRQ, and/or SNR) while the UE is communicating using a dedicated link with the network.

According to aspects, if the signal quality parameter of an RF chain passes a threshold (e.g., Param_X_threshold_search_min), the UE may configure the other RF chain to perform a search procedure. For example, if an RSRP, RSRQ, and/or SNR measurement of Antenna 0 passes a Param_X_threshold_search_min, the UE may configure Antenna 1 for performing the search procedure while Antenna 0 may continue to communicate with the network. In this manner, the UE may perform a search using the diversity antenna.

In aspects, while the search using Antenna 1 is in progress, the UE may compute and report channel quality indicator (CQI) information based on active Antenna 0.

In aspects, when the search using one RF chain is complete, the UE may return to diversity mode operations, where both RF chains may be used for communication with the network. Referring to the example above, when the search using Antenna 1 is complete, the UE may use both Antenna 0 and Antenna 1 to communicate with the network.

In aspects, if there is a change in a measured signal quality parameter such that the measured parameter no longer passes the threshold Param_X_threshold_search_min, the UE may suspend the search procedure and resume diversity mode operation with the network using both RF chains.

According to aspects, after suspending the search procedure, the UE may measure (e.g., continuously) a signal quality parameter. Upon determining a number of frames, M, for which a threshold signal quality parameter passes a threshold, the UE may resume the search by switching from diversity mode operation to searching using the diversity antenna. In this manner, a UE may reconfigure (e.g., dynamically) its RF chains between diversity mode operations and cell searching.

Aspects described herein provide adaptive control of RF chain configuration for searching purposes while a UE is in dedicated communication with a network. Accordingly, a user experience may improve during a data or voice call (e.g., using IP-Multimedia Subsystem (IMS) based voice). For example, the UE may be able to provide a list of PLMNs available to the user. The user may be able to select an HPLMN quickly.

A similar method may be applied for foreground (e.g., FPLMN) searches for camping on acceptable cells, which may also reduce search times.

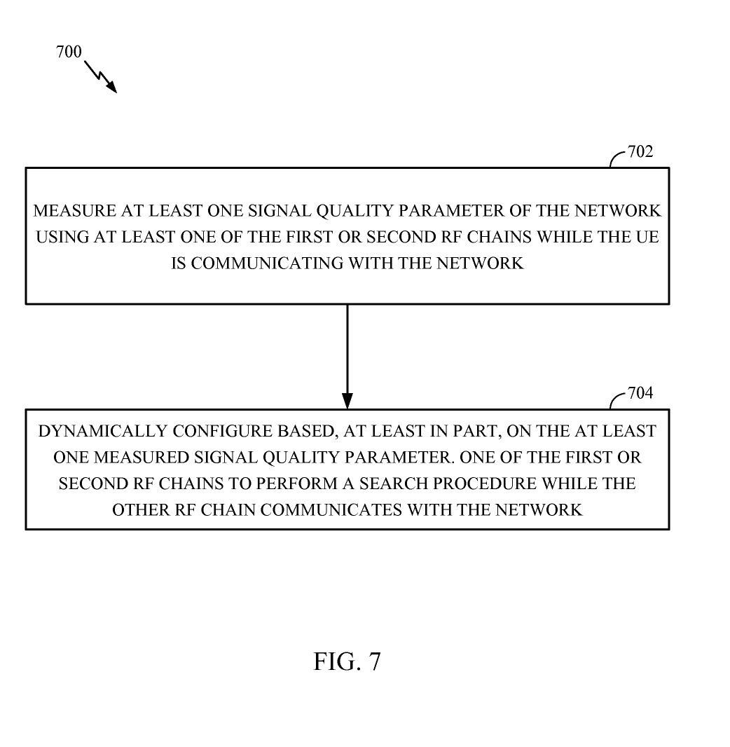

FIG. 7 shows a flow diagram illustrating operations 700 performed by a UE having at least a first and a second RF chain capable of communicating with a network. Operations 700 may be performed by a UE, such as UE 110 of FIG. 1, which may have one or more components of the UE 650 of FIG. 6.

At 702, the UE may measure at least one signal quality parameter of the network using at least one of the first or second RF chains while the UE is communicating with the network. As described above, the at least one signal quality parameter may include at least one of a RSRP, RSRQ, SNR and/or the like. At 704, the UE may dynamically configure based, at least in part, on the at least one measured signal quality parameter, one of the first or second RF chains to perform a search procedure while the other RF chain communicates with the network.

According to aspects, the UE may dynamically configure one of the first or second RF chains to perform the search by deciding, based on the measured at least one signal quality parameter, which of the RF chains to use to perform the search. The UE may decide which of the RF chains to use in performing the search by determining that the measured signal quality parameter passes a first threshold value for the first RF chain, and performing the search using the other (e.g., second) RF chain, while the UE continues to communicate with the network using the first RF chain. The UE may derive the first threshold value from one or more network provided threshold values.

As explained above, the UE may suspend the search on the second RF chain when the measured signal quality parameter no longer passes the first threshold value for the first RF chain. Thereafter, the UE may resume the suspended search using the second RF chain, if at least one signal quality parameter of the network measured using the first RF chain passes a threshold value.

### Compressed Mode Search During Connected Mode

During compresses mode gaps in LTE, TDSCDMA, and/or WCDMA, a UE may measure inter-frequency and/or inter-RAT cells provided by a network.

According to aspects of the present disclosure, the UE may measure at least one signal quality parameter of a network using both primary Antenna 0 (e.g., primary RF chain) and diversity Antenna 1 (e.g., diversity RF chain). The signal quality parameter may be at least one of a RSRP, RSRQ, SNR, or the like. If the measured signal quality parameter passes a first threshold for both RF chains, the UE may coordinate a cell search using Antenna 0 and Antenna 1 independently. As described in more detail below, a set of one or more carriers searched by the first RF chain may be different than a set of one or more carriers searched by the second RF chain. In this manner, more carriers may be searched in a given period of time than if both chains search the same carriers.

For example, coordinating a search procedure during compressed mode gaps using both RF chains may include dividing searching between RF chains such that interfrequency carriers of a same system (e.g., RAT) may be measured using one of the chains.

For interfrequency, inter-RAT searches, coordinating the search procedure may include performing inter-RAT interfrequency cell searches using a same RF chain. According to aspects, the interfrequency cells may include cells from an inter-RAT list. The other RF chain may perform searches for other cells.

According to aspects, coordinating the search procedure may include performing a first scan with interfrequency, inter-RAT cells divided between the two RF chains. During a second pass of measurements taken during, for example, subsequent compressed mode gaps, the UE may coordinate and perform a cell search based on detected cell energies by using one RF chain to measure cells with a detected cell energy passing a second threshold and using the other RF chain to measure one or more remaining cells. The detected cell energies may be based on at least one of a RSRP, RSRQ, SNR or the like. Thus, the device may identify stronger cells and track them using one RF chain, while using the other RF chain for remaining cells.

According to aspects, coordinating the search procedure may comprise searching for cells preferred (e.g., based on respective priorities) by the UE using one RF chain and searching for remaining cells using the other RF chain.

Through adaptive control of RF configurations for searching during compressed mode gaps, searching time may be reduced. For example, searching using both RF chains during compressed mode gaps may reduce searching time by 50%. In aspects, a UE may maintain a radio link when there are detected cells which may be measured quickly and reported to the network for handover purposes.

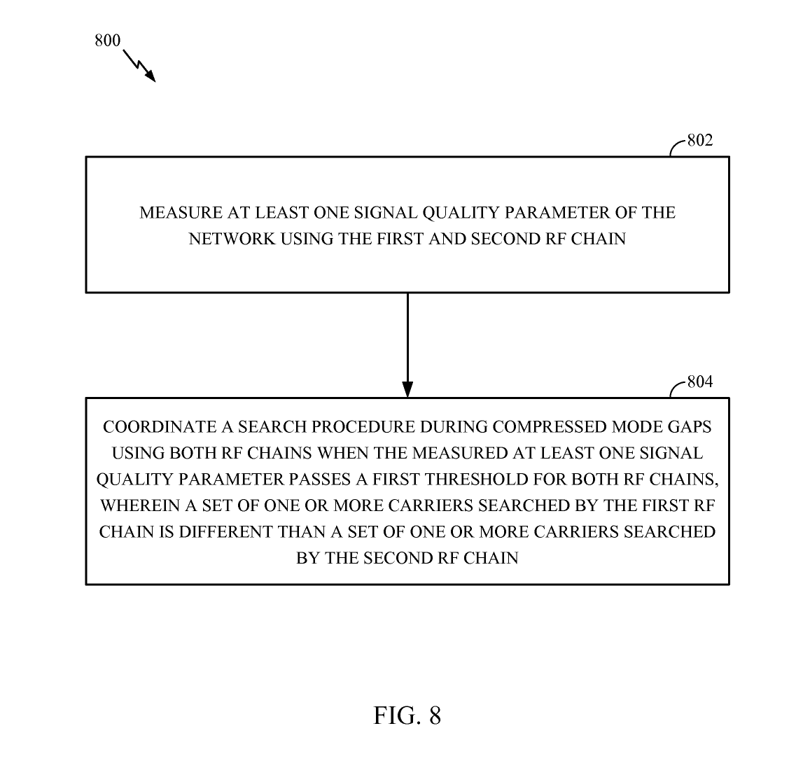

FIG. 8 shows a flow diagram illustrating operations 800 performed by a UE having at least a first and a second RF chain capable of communicating with a network. Operations 800 may be performed by a UE, including for example UE 110 of FIG. 1, which may have one or more components of the UE 650 of FIG. 6.

At 802, the UE may measure at least one signal quality parameter of the network using the first and second RF chains. At 804, the UE may coordinate a search procedure during compressed mode gaps using both RF chains when the measured at least one signal quality parameter passes a first threshold for both RF chains, wherein a set of one or more carriers searched by the first RF chain is different than a set of one or more carriers searched by the second RF chain. For example, the signal quality parameter may include at least one of a RSRP, RSRQ, and/or SNR. The UE may derive the first threshold value from one or more network provided threshold values.

As described above, the UE may coordinate the search in a number of manners. For example, the UE may measure interfrequency carriers of a same RAT using a same RF chain. The UE may coordinate the search by performing inter-RAT interfrequency cell searches using a same RF chain. The UE may coordinate a search by searching for cells preferred by the UE using one RF chain and searching for remaining cells using the other RF chain.

The UE may coordinate the search based on detected cell energies. For example, the UE may perform the cell search based on a detected cell energy by using one RF chain to measure cells with a detected cell energy passing a second threshold and using the other RF chain to measure one or more remaining cells. The detected cell energies may be based on a RSRP, RSRQ, and/or a SNR, for example.

### Example Methodologies

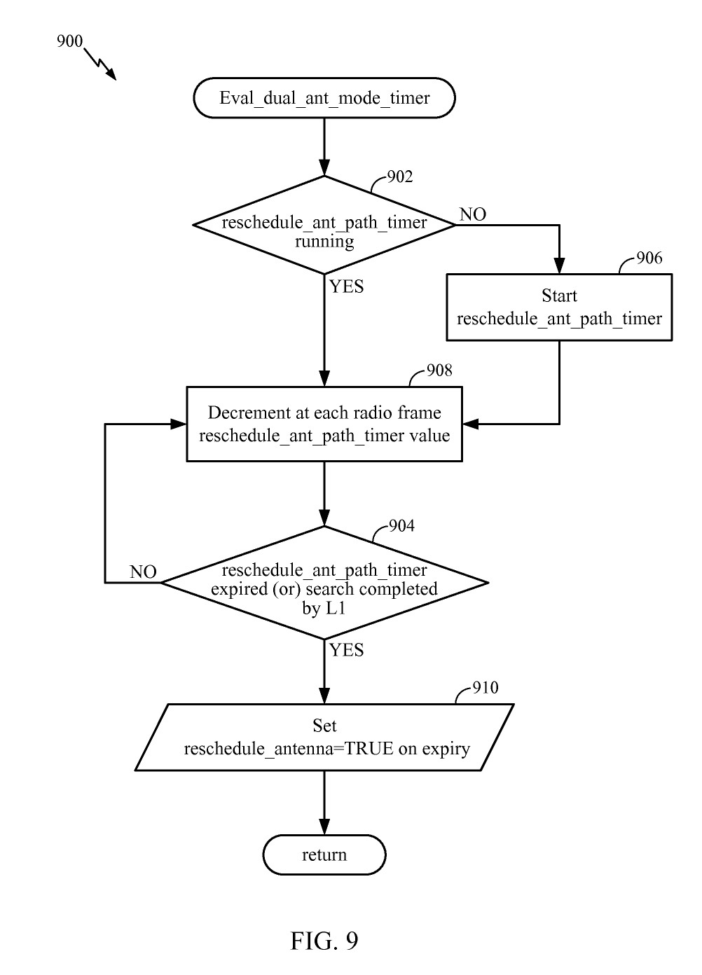

FIGS. 9-13 illustrate example methodologies for connected mode search optimizations, according to aspects of the present disclosure.

FIG. 9 illustrates an example methodology 900 involving dual antenna mode timer, performed by a UE, according to aspects of the present disclosure. At 902, the UE may determine if a dual antenna path timer is running. If the timer is not running, the UE may, at 906, start a reschedule antenna path timer. If the timer is running, the UE may, at 908, decrement the antenna path timer at each radio frame.

At 904, the UE may determine if the reschedule antenna path timer has expired and/or if the L1 layer of the UE has completed the search. If the antenna path timer has not expired or if the L1 layer has not completed the search, the UE may, at 908, decrement the antenna path timer at each radio frame. If the antenna path timer has expired or if the L1 layer has completed the search, the UE may, at 910, reschedule (e.g., reconfigure usage of) the antennas.

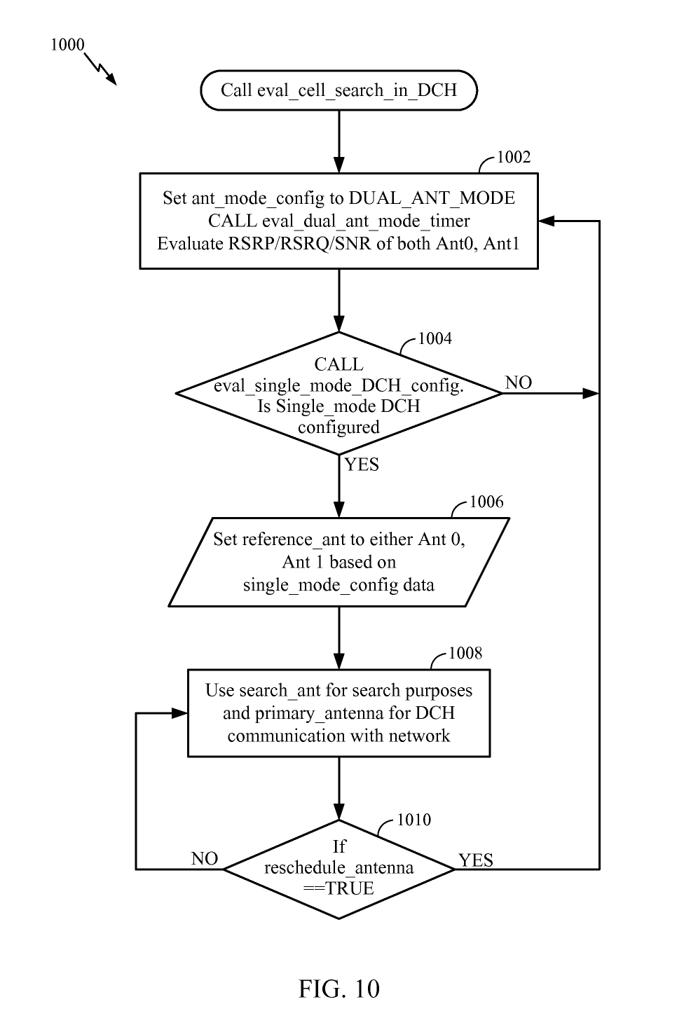

FIG. 10 illustrates an example methodology 1000 for performing a cell search while the UE is in a DCH state, according to aspects of the present disclosure. The UE may initially, at 1002, set the dual antenna mode timer as described in FIG. 9. The UE may also evaluate a signal quality parameter of the network using both Antenna 0 and Antenna 1. The signal quality parameter may include a RSRP, RSRQ, and/or SNR. At 1004, the UE may determine if a single mode DCH is configured. If the single mode DCH is configured, the UE may, at 1006, set a reference antenna to either Antenna 0 or Antenna 1, based on single mode configuration data. At 1008, the UE performs a search using the search antenna and may use the primary antenna for DCH communication with the network.

At 1010, the UE may determine if it needs to reschedule the antenna configuration. If so, the UE may, at 1002, set the antenna mode configuration to the dual antenna mode configuration and evaluate a signal quality parameter of the network using both Antenna 0 and Antenna 1. Otherwise, the UE may, at 1008, continue to use the primary antenna for DCH communication with the network and use the other antenna for search purposes.

If, at 1004, it is determined that the single mode DCH is not configured, the UE may set the antenna mode configuration to a dual antenna mode and begin the dual antenna mode timer. The UE may evaluate a signal quality parameter of the network using both Antenna 0 and Antenna 1.

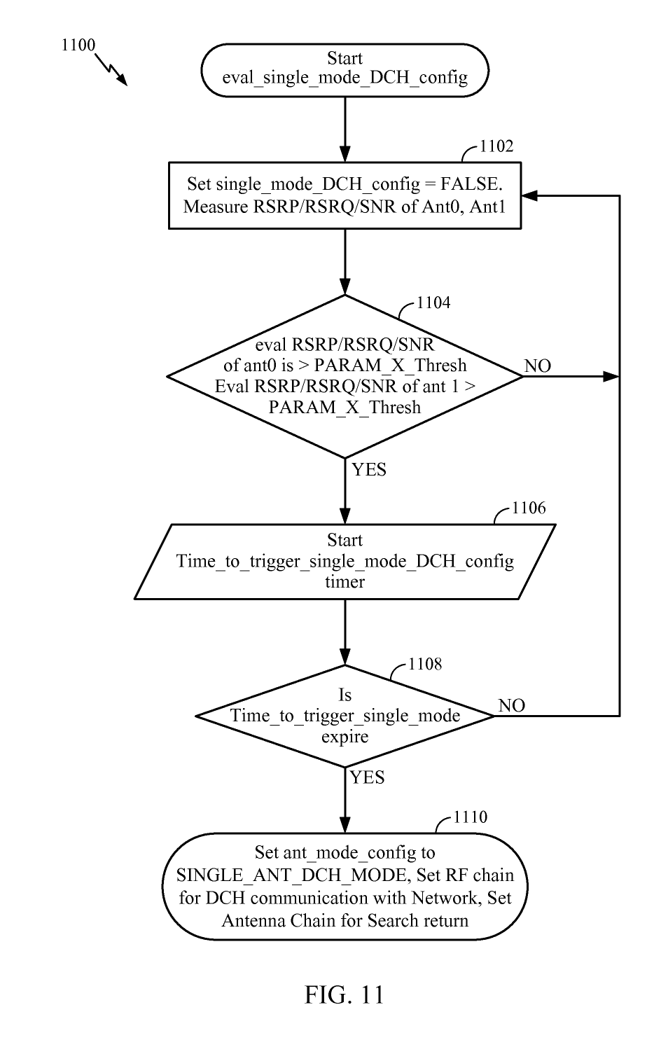

FIG. 11 illustrates an example methodology 1100 for a single chain DCH configuration, according to aspects of the present disclosure. The UE may, at 1102, measure a signal quality parameter of the network, including at least one of a RSRP, RSRQ, and/or SNR using both Antenna 0 and Antenna 1. At 1104, the UE may evaluate if the measured signal quality parameter of Antenna 0 and/or Antenna 1 passes a threshold. If so, at 1106, the UE may begin a time to trigger single mode DCH configuration timer. If the signal quality parameter of Antenna 0 and/or Antenna 1 fails to pass a threshold, the UE may, at 1102, continue to measure the signal quality parameter using both antennae.

At 1108, the UE may determine if the time to trigger the single mode has expired. If so, the UE may, at 1110 set the antenna mode configuration to a single antenna DCH mode. The UE may set one RF chain for DCH communication with the network and set another RF chain for searching. If not, the UE may, at 1102, continue to measure the signal quality parameter using both antennae.

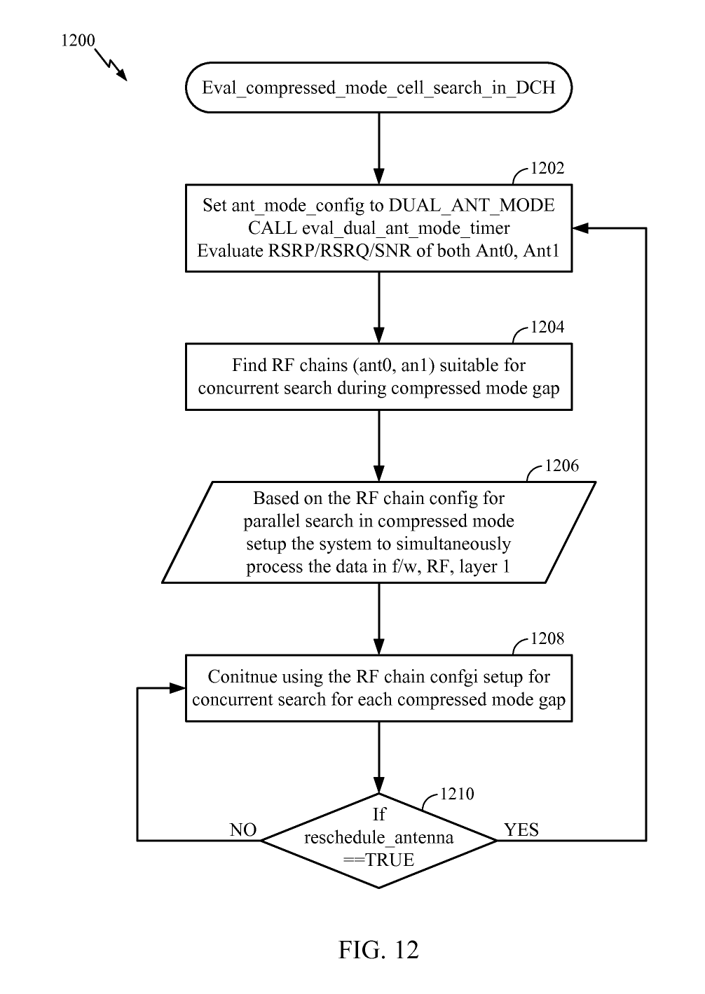

FIG. 12 illustrates an example methodology 1200 for a compressed mode cell search, according to aspects of the present disclosure. The UE may, at 1202, begin a dual antenna mode timer and may evaluate a signal quality parameter including, for example, a RSRP, RSRQ, and/or SNR using both Antenna 0 and Antenna 1. The UE may, at 1204, select a RF chain suitable for a coordinated search during compressed mode gaps. The UE may configure itself, at 1206, for parallel search during compressed mode gaps. At 1208, the UE may continue to use the current configuration setup for concurrent searching using Antenna 0 and Antenna 1 during each compressed mode gap.

At 1210, the UE may determine if it needs to reschedule the antennas. If the UE does not need to reschedule the antenna configuration, the UE may continue, at 1208, using the RF chain configuration established for a concurrent search for each compressed mode gap. If the UE does need to reschedule the antenna configuration, the UE may, at 1202, evaluate a dual antenna mode timer and evaluate a signal quality parameter.

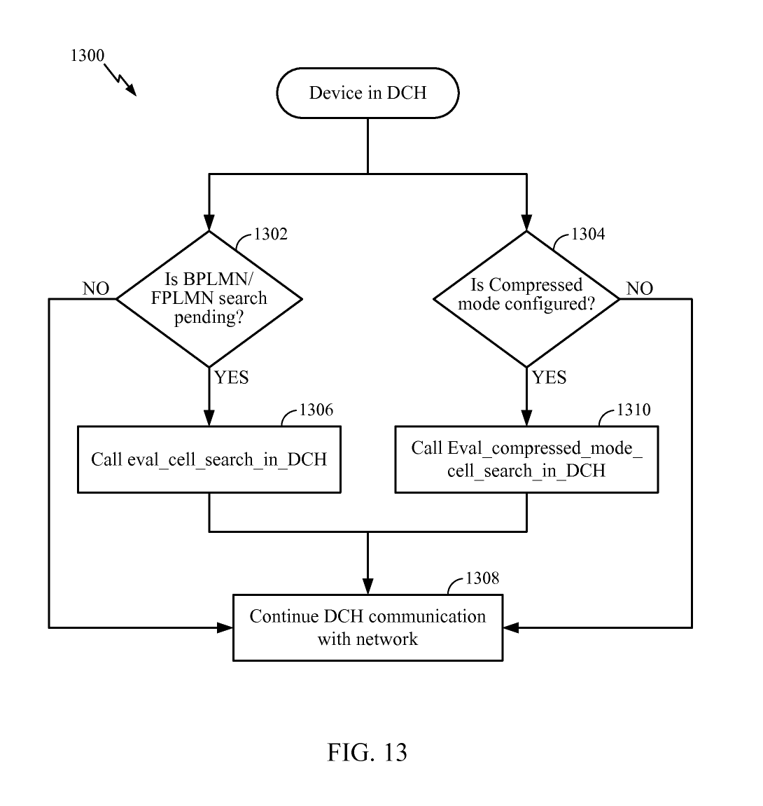

FIG. 13 illustrates an example methodology 1300 for a device operating in a DCH state, according to aspects of the present disclosure. At 1302, the UE may determine if a BPLMN or a FPLMN search is pending. If so, the UE may, at 1306, evaluate a cell search in DCH, as detailed, for example, in FIG. 10. If a BPLMN or FPLMN search is not pending, the UE may, at 1308, continue with DCH communication with the network.

At 1304, the UE may determine if a compressed mode is configured. If so, the UE may, at 1310, evaluate a compressed mode search as detailed, for example, in FIG. 12. If not, the UE may, at 1308, continue with DCH communication with the network.

Aspects of the present disclosure describe search improving and/or optimizing operations. For example, a UE may perform search procedures during a connected mode state using an RF chain (e.g., a diversity antenna). As described herein, during compressed mode gaps, a UE may independently use both RF chains for cell searching purposes, for example, when a signal quality parameter for both RF chains exceeds a threshold.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, a phrase referring to “at least one of” a list of items refers to any combination of those items, including single members. As an example, “at least one of: a, b, or c” is intended to cover: a, b, c, a-b, a-c, b-c, and a-b-c.

The previous description is provided to enable any person skilled in the art to practice the various aspects described herein. Various modifications to these aspects will be readily apparent to those skilled in the art, and the generic principles defined herein may be applied to other aspects. Although some aspects above are described in the context of dynamically configuring one of a first or second RF chain to perform a search procedure while the other RF chain communicates with the network based, at least in part, on at least one measured signal quality parameter, other aspects include coordinating a search procedure during compressed mode gaps using both RF chains when a measured signal quality parameter passes a first threshold for both RF chains, wherein a set of one or more carriers searched by the first RF chain is different than a set of one or more carriers searched by the second RF chain. Although the present methods and apparatus are described in the context of two receive chains, the present methods and apparatus may employ a larger number of receive chains and/or a subset of such larger number of receive chains. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communication by a user equipment (UE) having at least a first and a second radio frequency (RF) chain capable of communicating with a network, comprising:
measuring at least one signal quality parameter of the network using at least one of the first or second RF chains while the UE is communicating with the network; and
dynamically configuring based, at least in part, on the at least one measured signal quality parameter, one of the first or second RF chains to perform a search procedure while the other RF chain communicates with the network.

2. The method of claim 1, wherein the signal quality parameter includes at least one of a Reference Signal Received Power (RSRP), a Reference Signal Received Quality (RSRQ), or a Signal-to-Noise Ratio (SNR).

3. The method of claim 1, wherein dynamically configuring one of the first or second RF chains to perform the search comprises:
deciding, based on the measured at least one signal quality parameter, which of the RF chains to use to perform the search.

4. The method of claim 3, wherein deciding which of the first or second RF chains to use to perform the search comprises:
determining the measured at least one signal quality parameter passes a first threshold value for the first RF chain; and
performing the search utilizing the second RF chain while continuing communication with the network utilizing the first RF chain.

5. The method of claim 4, further comprising:
during the search, reporting a channel quality indicator (CQI) based on the first RF chain.

6. The method of claim 4, further comprising:
utilizing the second RF chain for communication with the network upon completion of the search.

7. The method of claim 4, further comprising:
suspending the search on the second RF chain when the measured at least one signal quality parameter no longer passes the first threshold value for the first RF chain.

8. The method of claim 7, further comprising resuming the suspended search on the second RF chain, if at least one signal quality parameter of the network measured after the suspending using at least one of the first RF chain passes a threshold value.

9. The method of claim 4, further comprising deriving the first threshold value from one or more network provided threshold values.

10. The method of claim 1, wherein the search includes a background public land mobile network (BPLMN) search.

11. A method for wireless communication by a user equipment (UE) having at least a first and a second radio frequency (RF) chain capable of communicating with a network, comprising:
measuring at least one signal quality parameter of the network using the first and second RF chains; and
coordinating a search procedure during compressed mode gaps using both RF chains when the measured at least one signal quality parameter passes a first threshold for both RF chains, wherein a set of one or more carriers searched by the first RF chain is different than a set of one or more carriers searched by the second RF chain.

12. The method of claim 11, wherein the search procedure includes measuring at least one of interfrequency carriers of inter-radio access technologies (RAT) or interfrequency carriers of a same RAT.

13. The method of claim 11, wherein the at least one signal quality parameter includes at least one of a Reference Signal Received Power (RSRP), a Reference Signal Received Quality (RSRQ), or a Signal-to-Noise Ratio (SNR).

14. The method of claim 11, further comprising deriving the first threshold value from one or more network provided threshold values.

15. The method of claim 11, wherein coordinating the search procedure comprises:
measuring interfrequency carriers of a same radio access technology (RAT) using a same RF chain.

16. The method of claim 11, wherein coordinating the search procedure comprises:
performing inter-radio access technology (RAT) interfrequency cell searches using a same RF chain.

17. The method of claim 11, wherein coordinating the search procedure comprises:
performing a cell search based on a detected cell energy by using one RF chain to measure cells with a detected cell energy passing a second threshold and using the other RF chain to measure one or more remaining cells.

18. The method of claim 17, wherein the detected cell energy is based on at least one of a Reference Signal Received Power (RSRP), a Reference Signal Received Quality (RSRQ), or a Signal-to-Noise Ratio (SNR).

19. The method of 11, wherein coordinating the search procedure comprises:
searching for cells preferred by the UE using one RF chain and searching for remaining cells using the other RF chain.

20. An apparatus having at least a first and a second radio frequency (RF) chain capable of communicating with a network, comprising:
means for measuring at least one signal quality parameter of the network using at least one of the first or second RF chains while the apparatus is communicating with the network; and
means for dynamically configuring based, at least in part, on the at least one measured signal quality parameter, one of the first or second RF chains to perform a search procedure while the other RF chain communicates with the network.

21. The apparatus of claim 20, wherein the signal quality parameter includes at least one of a Reference Signal Received Power (RSRP), a Reference Signal Received Quality (RSRQ), or a Signal-to-Noise Ratio (SNR).

22. The apparatus of claim 20, wherein the means for dynamically configuring one of the first or second RF chains to perform the search is configured to decide, based on the measured at least one signal quality parameter, which of the RF chains to use to perform the search.

23. The apparatus of claim 22, wherein deciding which of the first or second RF chains to use to perform the search comprises:
determining the measured at least one signal quality parameter passes a first threshold value for the first RF chain; and
performing the search utilizing the second RF chain while continuing communication with the network utilizing the first RF chain.

24. An apparatus having at least a first and a second radio frequency (RF) chain capable of communicating with a network, comprising:
means for measuring at least one signal quality parameter of the network using the first and second RF chains; and
means for coordinating a search procedure during compressed mode gaps using both RF chains when the measured at least one signal quality parameter passes a first threshold for both RF chains, wherein a set of one or more carriers searched by the first RF chain is different than a set of one or more carriers searched by the second RF chain.

25. The apparatus of claim 24, wherein the search procedure includes measuring at least one of interfrequency carriers of inter-radio access technologies (RAT) or interfrequency carriers of a same RAT.

26. The apparatus of claim 24, wherein the at least one signal quality parameter includes at least one of a Reference Signal Received Power (RSRP), a Reference Signal Received Quality (RSRQ), or a Signal-to-Noise Ratio (SNR).

27. The apparatus of claim 24, further comprising:
means for searching for cells preferred by the UE using one RF chain and searching for remaining cells using the other RF chain.

28. The apparatus of claim 24, wherein the means for coordinating the search procedure is configured to measure interfrequency carriers of a same radio access technology (RAT) using a same RF chain.

29. The apparatus of claim 24, wherein the means for coordinating the search procedure is configured to perform inter-radio access technology (RAT) interfrequency cell searches using a same RF chain.

30. The apparatus of claim 24, wherein the means for coordinating the search procedure is configured to perform a cell search based on a detected cell energy by using one RF chain to measure cells with a detected cell energy passing a second threshold and using the other RF chain to measure one or more remaining cells.
